(19) United States
(12) Patent Application Publication
(10) Pub. No.: US 2007/0130465 A1
(43) Pub. Date: Jun. 7, 2007

(54) VIRTUAL SUBSCRIBER IDENTIFIER SYSTEM AND METHOD

(75) Inventors: Ke ZENG, Beijing (CN); Xiao-Wei Liu, Beijing (CN); Xiao-Han Wang, Beijing (CN); Ya-Bo Wang, Beijing (CN); Hui-Feng Liu, Beijing (CN); Tomoyuki Fujita, Yokohama (JP); Min-Yu Hsueh, Beijing (CN)

Correspondence Address: SUGHRUE MION, PLLC, 2100 PENNSYLVANIA AVENUE, N.W., SUITE 800, WASHINGTON, DC, 20037, US

(73) Assignee: NEC (China) CO., LTD.

(21) Appl. No.: 11/553,205

(22) Filed: Oct. 26, 2006

(30) Foreign Application Priority Data
Oct. 27, 2005 (CN) 200510114795.X

(51) Int. Cl. H04L 9/00

(52) U.S. Cl. 713/171

(57) ABSTRACT

The invention provides a virtual subscriber identifier system and method of a communication network. According to one embodiment of the invention, a subscriber generates virtual subscriber identifiers by him/her self, generates a subscriber identity mapping data by which a identifier service provider can figure out the real identifier of the owner of the virtual subscriber identifier, and informs peers of the virtual subscriber identifiers. The subscriber identify mapping data may be a data in which a virtual subscriber identifier is associated to the real identifier of the subscriber, and be registered by the subscriber with the identifier service provider. A peer generates a communicating request including a virtual subscriber identifier as target, and sends the request to the identifier service provider, the identifier service provider determines the real identifier of the subscriber from the subscriber identity mapping data, and forwards the communication between the peer and the subscriber's terminal. In another embodiment, the subscriber identity mapping data may be a secret data of the subscriber, by which the virtual subscriber identifier can figure out the real identifier of the subscriber. When receiving the communication request, the identifier service provider decrypts the real identifier of the owner of the virtual subscriber identifier from the secret data received from the peer. In one embodiment, the virtual subscriber identifier is generated from the public key of the subscriber. The virtual subscriber identifier may be equipped with a certificate, or be associated with a magic word. With the invention, the use of the virtual subscriber identifiers is more flexible to the system and versatile to the subscriber.

### TECHNICAL FIELD

The intention relates to communication networks, and more particularly to communication system capable of preserving the privacy of its users.

### BACKGROUND

A common fact in today's communication networks is that each subscriber of the network must be uniquely identified.

For instance, in fixed telecommunication network, the subscriber is uniquely identified by phone number. In GSM and CDMA network, the subscriber is uniquely identified by IMSI (International Mobile Subscriber Identifier) as well as ISDN (international Subscriber Digital Number). One IMSI uniquely corresponds to one ISDN. In Internet Email system, one email account identifies one subscriber.

There are many cases, where the unique link between subscriber and the network identifier becomes problematic for the subscriber'privacy.

For instance, a telephone network subscriber is looking for an apartment, say on the World Wide Web (WWW). It's rational of the subscriber not to give out his/her real phone number. For another instance, the subscriber meets a new person over the Internet, it's wise of the subscriber not to give out his/her real phone number or email address. In the third instance, the subscriber is registered to an Internet Service Provider (ISP), the subscriber may wish to remain anonymous toward the ISP therefore withholding his/her real phone number or email address.

Obviously, above examples instantiate the necessity for the subscriber to give out different identifier for different purpose. However, it's not so effortless for the subscriber to get the different identifiers necessary for different purposes. To get a new fixed, or landline, phone number, the subscriber has to pay a special amount of money to the network operator and in most cases wait some time for the phone line to be ready. To get a new mobile phone number, the subscriber has to purchase a phone card in which the mobile phone number is embedded. If the subscriber would like to discard the phone number, either fixed or mobile, there's no refund and in some case he/she may have to pay additional money to the network operator. In terms of email address, it's true that most free email service providers do not care about whether one person registers multiple email accounts with the email service provider, which implies that the subscriber can get multiple email accounts for free. Whereas, it merely means that acquiring multiple email accounts may be free in money terms. To get an email account, the subscriber must go through the somewhat complicated registration flow mandated by the email service provider. In other words, registering multiple email accounts is never free in terms of time expense.

Even if the subscriber would like to stand the cost on money and time, above description still doesn't foster a viable solution. If a subscriber has to write down and remember for what purpose and to whom one phone number or email address is given out, the subscriber may soon feel exhausted and look for alternative solution to address his privacy concerns.

To summarize, from the subscriber'perspective, a feasible and convenient solution is necessary, where the solution should:

1) be able and hand for the subscriber to give out different identifier for different purpose;

2) be easy and convenient for the subscriber to manage the identifiers that have been given out or to be given out; and

3) be flexible and diversiform to communicate over the identifiers.

Traditionally, the subscriber can be forced to request a new identifier from the network operator or email service provider each time the subscriber intends to give out an identifier for special purpose.

FIG. 16 illustrates the traditional solution. Here, the subscriber contacts the identifier provider (network operator or email service provider) for a new identifier. After issuance of a new identifier i, the subscriber can give out this identifier to particular peer or peers depending on the subscriber's purpose. Note that the identifier provider must maintain a mapping between identifier i and the true identifier of the subscriber.

FIG. 17 illustrates how a peer can communicate with subscriber over the identifier i given out by the subscriber in a traditional solution. The peer needs to contact the identifier provider requesting communication targeted to identifier i. The identifier provider maps identifier i to the certain subscriber. According to the subscriber's policy, the identifier provider may forward the communication request to the subscriber and thereafter the subscriber and peer can communicate with each other.

The disadvantages of above traditional solution are quite obvious.

First, any time the subscriber needs a new identifier, he/she must contact the identifier provider for issuance of the identifier. As has been described, this is not as handy as anticipated.

Second, there's no systematic help for the subscriber to manage many identifiers given out of many peers, respectively. As has been described in previous section, this is not as convenient as expected.

Third, the system merely provides forwarding service, i.e. peer looks for communication with particular identifier known to the identifier provider and the identifier provider forwards the communication request to the subscriber. The concrete examples include telephone call forwarding and Internet email forwarding. However, the subscriber may have other important requirements that are not satisfied by the traditional solution. For instance, the subscriber may want to use identifier i to originate communication with peers. The subscriber may prefer a system notification of peer communication request and later use identifier i to call back. The system may ask peers for special magic word attached with identifier i, only the peer that knows the correct magic word can be connected to subscriber.

Finally, there's no Peer trust over the identifier i. Only when the peer really being connected to the subscriber, may the peer really accept identifier i. There's no way for the Peer to judge the authenticity of identifier i without really originating communication toward identifier i. This may cause the Peer to hesitate from acceptance of identifier i.

### SUMMARY OF THE INVENTION

The invention provides a Virtual Subscriber Identifier system and the method for a communication network.

According to one aspect of the invention, a subscriber terminal in a communication network is provided, comprising virtual subscriber identifier generation means for generating a virtual subscriber identifier; subscriber identity mapping data generation means coupled to the virtual subscriber identifier generation means, the subscriber identity mapping data generation means being adapted to generate a subscriber identity mapping data used for an identifier service provider to associate the virtual subscriber identifier to the real identifier of the subscriber; and communication means communicatively coupled to the identifier service provider, the communication means being adapted to communicate with other subscriber terminals using the virtual subscriber identifier via the identifier service provider.

According to another aspect of the invention, a method for a subscriber to communicate with peers over a communication network, while preserving the subscriber's privacy is provided, comprising: generating a virtual subscriber identifier; generating a subscriber identity mapping data used for an identifier service provider to associate the virtual subscriber identifier to the real identifier of the subscriber; informing at least one peer of the virtual subscriber identifier; and communicating with the peer using the virtual subscriber identifier via the identifier service provider, wherein the real identifier of the owner of the virtual subscriber identifier is determined by the virtual subscriber identifier based on the identity mapping data.

According to another aspect of the invention, a communication server for forwarding a communication in a communication network is provided, comprising subscriber identity mapping data storage means for storing subscriber identity mapping data, the identity mapping data being used for an identifier service provider to associate a virtual subscriber identifier generated by a subscriber to the real identifier of the subscriber, subscriber identity determination means coupled to the subscriber mapping data storage means, wherein in response to a communication request including the virtual subscriber identifier as target from a peer of the subscriber, the subscriber identity determination means determines the real identifier of the owner of the virtual subscriber identifier based on the subscriber identity mapping data; and communication forwarding means coupled to the subscriber identity determination means, the communication forwarding means being adapted to forward the communication between the peer and the terminal of the determined subscriber.

According to another aspect of the invention, a method for forwarding a communication in a communication network is provided, comprising; receiving subscriber identity mapping data, the identity mapping data being used for associating a virtual subscriber identifier generated by a subscriber to the real identifier of the subscriber; storing the subscriber identity mapping data in a memory; receiving a communication request from a peer of the subscriber, the communication request including the virtual subscriber identifier as target, determining the real identifier of the owner of the virtual subscriber identifier from the subscriber identity mapping data; and forwarding the communication between the peer and the subscriber's terminal.

According to another aspect of the invention, a method for communication over a communication network, while preserving privacy is provided. The network comprises at least one subscriber terminal, at least one peer of the subscriber terminal and an identifier service provider coupled to the subscriber terminal and the peer. The method comprises that the subscriber terminal generates a virtual subscriber identifier and a subscriber identity mapping data used for the identifier service provider to associate the virtual subscriber identifier to the real identifier of the subscriber, and informs the peer of the virtual subscriber identifier; the peer generates a communication request including the virtual subscriber identifier as target, and sends the request to the identifier service provider, and the identifier service provider determines the real identifier of the subscriber from the subscriber identity mapping data, and forward the communication between the peer and the subscriber terminal.

According to another aspect of the invention, a system for communication by virtual identifiers over a communication network is provided, comprising at least one subscriber terminal, at least one peer and a communication server coupled to the subscriber terminal and the peer, wherein the subscriber terminal comprises: virtual subscriber identifier generation means for generating a virtual subscriber identifier, subscriber identity mapping data generation means coupled to the virtual subscriber identifier generation means, the subscriber identify mapping data generation means being adapted to generate a subscriber identity mapping data used for an identifier service provider to associate the virtual subscriber identifier to the real identifier of the subscriber, and communication means communicatively coupled to the identifier service provider, the communication means being adapted to communicate with other subscriber terminals using the virtual subscriber identifier via the identifier service provider, the identifier service provider comprises: subscriber identity mapping data storage means for storing the subscriber identify mapping data; and subscriber identity determination means coupled to the subscriber mapping data storage means, wherein in response to a communication request including the virtual subscriber identifier as target from the, the subscriber identity determination means determines the real identifier of the owner of the virtual subscriber identifier based on the subscriber identity mapping data, and communication forwarding means coupled to the subscriber identify determination means, the communication forwarding means being adapted to forward the communication between the peer and the terminal of the determined subscriber.

### BRIEF DESCRIPTIONS OF THE DRAWINGS

The foregoing and other objects of the invention, the various features thereof, as well as the invention itself, may be more fully understood from the following description, when read together with the accompanying drawings in which the like numeral reference indicates the like parts, and in which:

FIG. 1 is a flow chart illustrating the exemplary process according to one embodiment of the invention;

FIG. 2 is a block diagram illustrating an example of the subscriber terminal according to one embodiment of the invention;

FIG. 3 is a block diagram illustrating an example of the identifier service provider according to one embodiment of the invention;

FIG. 4 is a diagram illustrating an example of the dataset of the subscriber identity mapping data;

FIG. 5 is a flow chart illustrating the process according to another embodiment of the invention;

FIG. 6 is a block diagram illustrating an example of the identifier service provider according to this embodiment of the invention;

FIG. 7 is a diagram illustrating the process when a magic word is required;

FIG. 8 is a block diagram illustrating an example of the subscriber terminal according to one embodiment;

FIG. 9 is a block diagram illustrating an example of the identifier service provider according to one embodiment;

FIG. 10 is a diagram illustrating an example of the dataset maintained by the identifier service provider;

FIG. 11 is a diagram illustrating the process according to one embodiment;

FIG. 12 is a diagram illustrating the process according to one embodiment;

FIG. 13 is a diagram illustrating the process according to one embodiment;

FIG. 14 is a diagram illustrating the process according to one embodiment;

FIG. 15 is a diagram illustrating the process according to one embodiment;

FIG. 16 is a diagram illustrating the traditional solution where a subscriber contacts a identifier provider for a new identifier;

FIG. 17 is a diagram illustrating how a peer can communicate with subscriber over a identifier in a traditional solution;

FIG. 18 is a flow chart showing an exemplary process flow generating anonymous public keys according to the APK technique;

FIG. 19 is a block diagram showing an exemplary device for generating anonymous public keys in accordance with the APK technique; and

FIG. 20 is a diagram showing an exemplary procedures of encryption and decryption of a message in accordance with the APK technique.

### DETAILED DESCRIPTION OF THE PREFERRED EMBODIMENTS

The invention is made in view of the above disadvantages of the prior art.

FIG. 1 is a flow chart illustrating the exemplary process according to one embodiment of the invention. As shown in FIG. 1, a privacy-conscious subscriber generates Virtual Subscriber identifier (VSI) and registers the VSI with the identifier service provider. This differs from the traditional solution in that the VSI is not issued from the identifier service provider. Instead, it is generated by the subscriber. The identifier service provider here is different from that of the conventional identifier provider which assigns the identifiers to the subscribers. Candidate VSIs may be phone numbers and email accounts, for example.

There are many methods for generating VSIs. For example, the subscriber can choose a VSI arbitrarily, then asks the identifier service provider for confirmation. After the identifier service provider assures that this VSI has not been assigned to others, this VSI can be registered as one VSI of the subscriber. However, a VSI only can be assigned to one subscriber. It is possible that many subscribers have the same choice on VSI, therefore, a collision may occur. If a collision happens, the registration fails and the subscriber should choose another VSI. The method used by the invention to constrain the collision probability is explained below.

In a preferred embodiment of the invention, the VSIs are generated by a algorithm which constrains the collision probability to a lower level. In one embodiment of the invention, a VSI is generated from a public key of the subscriber. For example, any secure hash algorithm may be employed to generate a VSI as Hash (PKᵤ), where PKᵤ is a public key of the subscriber, and Hash (PKᵤ) is a hash value of the PKᵤ. To generate different VSIs, a number r may be used. For example, the VSI can be generated as Hash (r, PKᵤ), i.e., hash value of the combination of r and PKᵤ. For example, the combination of r and PKᵤ may be obtained by attaching the number r to the end of PKᵤ. The number r may be a random number. All the generated VSIs are different from each other as long as r is generated by a good random generator and the hash algorithm is secure. For more information about the hash algorithm, please see A. Menezes, P. van Oorschot, S. Vanstone, Handbook of Applied Cryptography, CRC Press, 1996, which is incorporated by reference.

The collision probability is explained as follows. Taking the hashing approach described above as an example, and supposing that one VSI takes n bits (consequently there are totally 2ⁿ combination of all possible VSIs) and that every subscriber generates VSI independently, the probability for 2 VSIs to be the same will be 50% after 1.2×2^{n/2} VSIs have been generated. For example, if n=67, the probability of one collision is 0.5 after 14577602399 VSIs are generated. For a subscriber group at the level of 10 million, if each subscriber on average generates 1500 VSIs, one collision will occur at a probability around 0.5. For another example, if n=78, the probability of one collision is 0.5 after 659706976665 VSIs are generated. For the group of 100 million, one collision at probability about 0.5 requires on average each subscriber generates 6600 VSIs. In the worst case, the 0.5 probability unfortunately happens, only two subscribers (and peers of one subscriber) among the total 100 million will sense the trouble. However after each subscriber on average generates 6600 VSIs, this should be quite acceptable to the system operator since other system failures may occur at much higher probability, e.g., server or network down, and much more subscribers will be affected by those failures.

As explained above, in the case that the VSI is generated by the subscriber and registered with the identifier service provider, if the VSIs are generated by a algorithm which constrains the collision probability to a certain level, the VSIs generated by the subscriber can easily get confirmation at the identifier service provider. If the collision probability of the VSIs generated by each subscriber is sufficiently suppressed, it is possible for the subscriber to inform a peer of his/her VSI before the VSI is registered with the identifier service provider.

In one embodiment of the invention, a user can simultaneously possess several incomparable public keys wherein all these public keys correspond to a single private key, and the VSIs are generated from the incomparable public keys. For more information about the hash algorithm, please see B. R. Waters, E. W. Felten, A Sahai, Receiver Anonymity via Incomparable Public keys, CCS'03, Washington, D.C., USA, pp. 112-121, which is incorporated by reference.

In another embodiment of the invention, a VSI is generated from an anonymous public key apk of the subscriber. For example, the VSI can be generated as Hash (apk), i.e., hash value of the anonymous public key apk. Since all the anonymous public keys of the subscriber are different from each other, this approach does not necessarily incorporate additional random number. The above-mentioned anonymous public key can generated by the Anonymous Public Key (APK) technique set forth by Ke Zeng and Tomoyuki Fjjita in the Chinese patent application serial No. 200410090903.X, entitled with “Methods, Devices and Systems for Generating Anonymous Public Key in a Secure Communication System”, filed by NEC (China) Co., Ltd on Nov. 10, 2004, which is incorporated by reference. Please see the last portion of the description for the detailed solution of APK technique.

When the VSI is generated from an anonymous public key apk of the subscriber, it's possible for the subscriber to prove that the VSI actually belongs to him/her. Simply speaking, the subscriber will demonstrate the apk to the verifier. Since Flash( ) is secure hash algorithm, it's infeasible for anybody else to find another anonymous public key that can be hashed to the same VSI. Now as long as the subscriber can prove to the verifier that he/she knows the private-key xᵤ that corresponds to anonymous public key apk, his/her ownership of the VSI will be ascertained. It's notable that in traditional approach, proving ownership of the VsI is impossible, since otherwise the subscriber must demonstrates his/her unique public key PKᵤ to the verifier. Since all the VSIs the subscriber generated can be correlated by the unique PKᵤ, it is not desirable when the subscriber concerns his/her privacy.

FIG. 2 is a block diagram illustrating an example of the subscriber terminal according to one embodiment of the invention. As shown in FIG. 2, the subscriber terminal 200 mainly comprises a virtual subscriber identifier generation unit 201 for generating VSIs of the subscriber, a subscriber identity mapping data generation unit 202 coupled to the virtual subscriber identifier generation unit for generate a subscriber identify mapping data used for an identifier service provider to associate the VSIs to the real identifier of said subscriber and a communication unit 203 coupled to the identifier service provider for communicating with other subscriber terminals using the VSI via the identifier service provider. The subscriber identity mapping data said here is a data by which the identifier service provider can associate the virtual subscriber identifier to its owner either directly or indirectly.

In one embodiment in accordance with the invention, the subscriber identity mapping data comprises the VSI in association with the real identifier of the subscriber, and the subscriber terminal further comprises a subscriber identity registering unit coupled to the subscriber identify mapping data generation unit 202. The virtual subscriber identifier generation unit 201 computes VSIs and sends the VSIs to the subscriber identity mapping data generation unit 202. The subscriber identity mapping data generation unit 202 generates the subscriber identity mapping data as such data in which the VSIs are in association with the real identifier of the subscriber. The subscriber identity registering unit register the subscriber identity mapping data with the identifier service provider. The subscriber informs other peers of his/her VSIs by sending a notification through some commutation means, or by a letter, by an email by word of mouth, and so on.

After the identifier service provider registers the VSIs of the subscriber in association with the real identifier of the subscriber, and a peer knows one of the VSIs of the subscriber, the peer can call that VSI to communicate with the subscriber. The communication request is sent to the identifier service provider, and upon receiving the request, the identifier service provider maps the VsI to the subscriber by the registered subscriber identity mapping data, and forwards the communication between the subscriber and the peer. The subscriber receives/transmits the communication data from/to the identifier service provider by the communication unit 203.

The subscriber terminal 200 may be a computer apparatus in a network, and further comprises other units known in the art, such as an input unit for the user to input the instruction, a display unit for display data and information on a screen, a memory unit for storing data and instructions, a network interface for connecting to a network, a central process unit for performing computation, etc. The subscriber terminal 200 may be a mobile phone, and further comprises other units known in the art, such as a key input unit, a liquid crystal display, a radio receiving unit, a radio transmitting unit, etc.

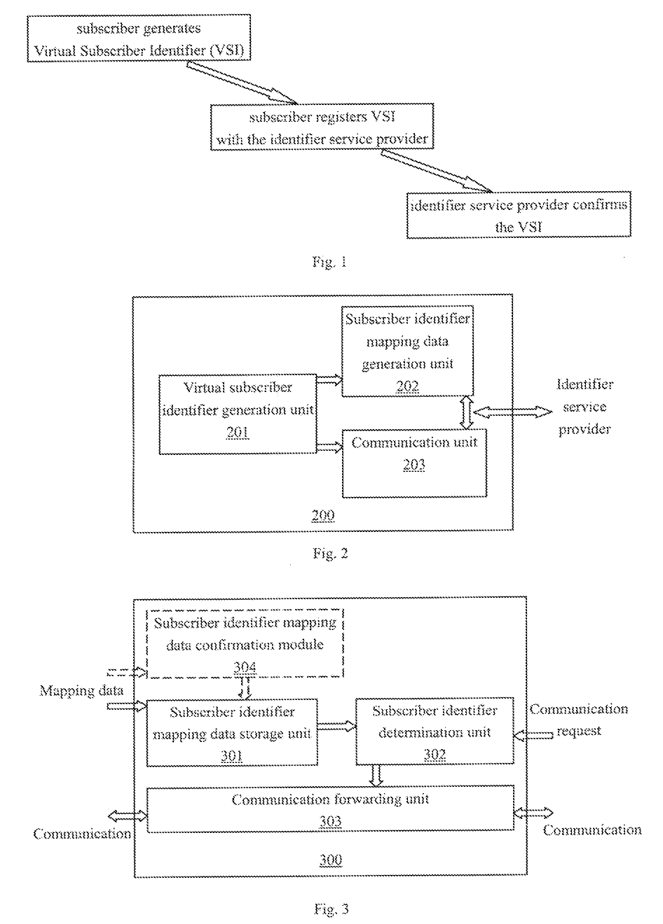

FIG. 3 is a block diagram illustrating an example of the identifier service provider according to one embodiment of the invention. As shown in FIG. 3, the identifier service provider 300 mainly comprises a subscriber identity mapping data storage unit 301 for storing subscriber identity mapping data received from the subscriber, a subscriber identity determination unit 302 for determining the owner of the VSIs by the subscriber identity mapping data, and a communication forwarding unit 303 for forwarding the communication between the subscribers.

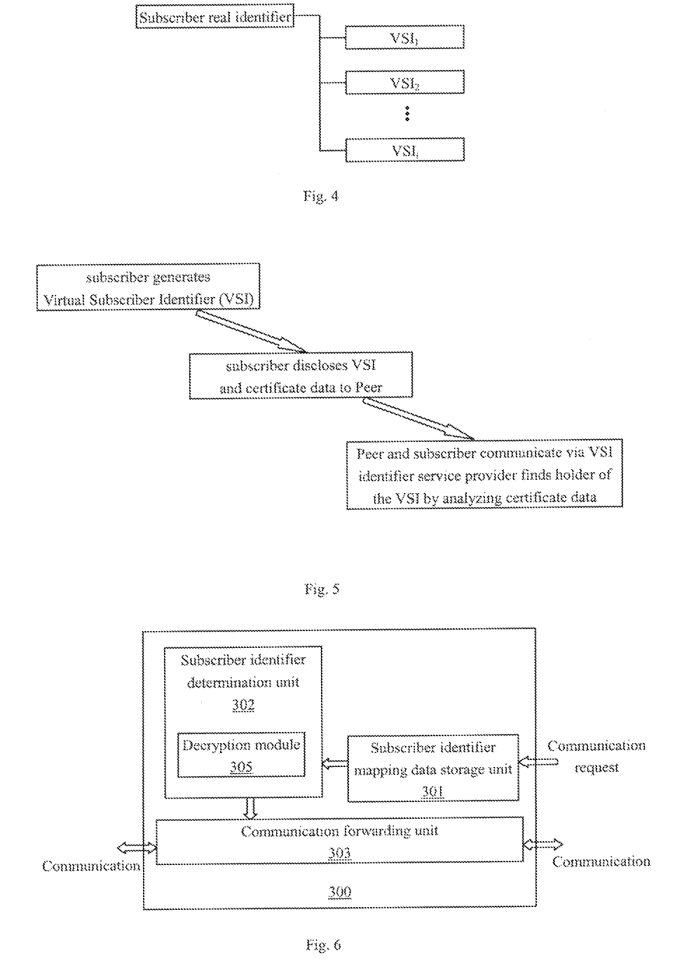

The subscriber identity mapping data storage unit 301 stores the VSIs received from the subscriber. The VSIs are stored in a memory as a dataset, in which each VSI is associated with the owner of VSI, i.e., the real identifier of the subscriber. FIG. 4 shows an example of the dataset.

Referring back to FIG. 3, the identifier service provider 300 may further comprises a subscriber identity mapping data confirmation unit 304. The virtual subscriber identity mapping data confirmation unit 304 checks whether the VSI sent from the subscriber is conflict with those have been registered by other subscriber in the past. If the VSI has not been used by other subscribers, the subscriber identity mapping data confirmation unit 304 indicates that the VSI can be registered, and generates a confirmation of the VSI which could be fed back to the subscriber.

After a VSI has been registered with the identifier service provider, a peer in the network can originate a communication taking the VsI as the target. Upon receiving the communication request from the peer, subscriber identity determination unit 302 of the identifier service provider search for the same VSI in the dataset maintained by the subscriber identity mapping data storage unit 301. If the VSI is found in the dataset, the communication forwarding unit 303 transmits a signal to the subscriber whose real identifier is associated with that VSI to inform the incoming call from the peer. After receiving the acknowledge signal, the communication forwarding unit 303 forwards the communication between the peer and the corresponding subscriber.

The identifier service provider 300 may be a communication base station, an email server or other network server, and may further comprise the known unit in the art.

It has described that the peer originates a communication taking a VSI as target after the VSI and the real identifier of the subscriber has been registered associatively by the identifier service provider. There is another embodiment of the invention.

FIG. 5 is a flow chart illustrating the process according to another embodiment of the invention. As shown in FIG. 5, the subscriber generates the VSI and gives out the VSI directly to a peer. Here, the VSI is attached with a special certificate data. The certificate data allows the peer to verify the authenticity of VSI. On the other hand, the certificate data comprises a secret data of the subscriber, by which the identifier service provider can figure out the real identifier of the owner of the VSI, i.e. the subscriber, when peer later on contacts identifier service provider for communication with own of the VSI. In particular, the subscriber identify mapping data generated by the subscriber comprises a secret data which allows the virtual subscriber identifier to figure out the real identifier of the owner of the VSI. The subscriber gives his/her VSI along with the subscriber identity mapping data (for example, a certificate data incorporating the secret data of the subscriber) to the peer. When the peer generates a communication request, he/she sends the VSI along with such subscriber identity mapping data that incorporating the secret data to the identifier service provider. The identifier service provider decrypts the secret data to find the owner of the VSI. Then the identifier service provider forwards the communication between the peer and the owner figured out from the certificate.

For example, the subscriber encrypts its real identifier with public key of the identifier service provider to generate a secret data. If the encryption is probabilistic, such as ElGamal, nobody else can figure out real identifier of the subscriber through analyzing the ciphertext (i.e. public key encrypted real identifier). The secret data is included in the data given to the peer. When the peer generates the communication request, the secret data is transferred from the peer to the identifier service provider. The identifier service provider can easily decrypt the cipher text using its private-key and recover real identifier of the subscriber. By this way, the subscriber can generate and us his VSIs with no need of registering the VSIs with the identifier service provider.

The other secret data may be used as long as the identifier service provider can decrypt the real identifier from it but the other peer cannot. The secret data said here is an encrypted data for the identifier service provide r to discover the owner of the virtual subscriber identifier from it, either directly or indirectly.

The subscriber terminal according to this embodiment of the invention is similar to that shown in FIG. 2. However, the subscriber identity mapping data generation unit 202 may include a secret data generation module for generating the secret data corresponding to the real identifier of the subscriber such that said identifier service provider can discover said real identifier of the subscriber from the secret data, the subscriber identity mapping data generation unit 202 generates the subscriber identity mapping data that incorporates the secret data.

FIG. 6 is a block diagram illustrating an example of the identifier service provider according to this embodiment of the invention. The identifier service provider 600 comprises a subscriber identity mapping data storage unit 301 for storing subscriber identity mapping data received from the originator of the communication, a subscriber identity determination unit 302 for determining the owner of the VSIs by the subscriber identity mapping data, a communication forwarding unit 303 for forwarding the communication between the subscribers. The subscriber identity determination unit 302 comprises a decryption module 305. The decryption module 303 is used to decrypt the secret data contained in the subscriber identity mapping data received from the originator of the communication.

In another embodiment of the invention, the subscriber generates magic words corresponding to the VSIs and sends them to the peer and the identifier service provider. The identifier service provider stores the magic word in association with the VSI. The magic word could be a number, a word phrase or any data which can be inputted by a peer, and it can help confirm the validity of VSI inputted by a peer. If the magic word inputted by the peer does not conform to that preset by the subscriber, the call is deemed to be originated by mistake. The detail process is as follows.

Upon receiving a communication request, the identifier service provider ask the peer who originates the communication for the magic word. If the magic word received from the peer confirms to the magic word appointed by the owner of the VSI, the identifier service provider forwards the communication between the peer and the owner of the VSI. Otherwise, the communication will not be forwarded.

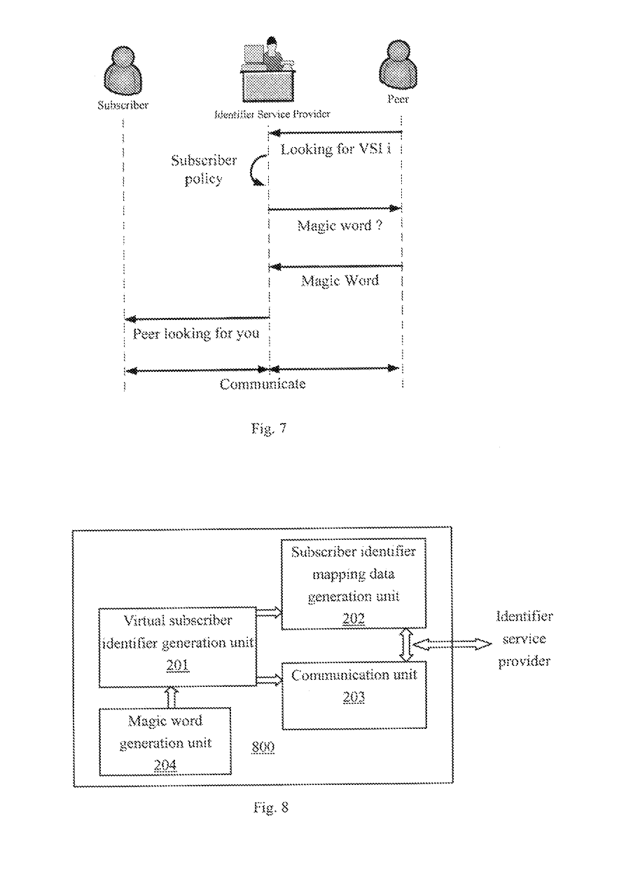

FIG. 7 illustrates the process when a magic word is required.

FIG. 8 is a block diagram illustrating the example of the subscriber terminal according to this embodiment. The subscriber terminal 800 is similar to that shown in FIG. 2, but further comprises a magic word generation unit 204 for generating magic words corresponding to the VSIs.

The magic word can be generated in various ways. For example, the magic word may be generated as a random number. In this case, the magic word generation unit 204 could simply by a random number generator. In another implementation, the number of bits of the random number may be set or controlled by the user. Various methods to construct such random number generator in either software or hardware are known in the art, and therefore, the detailed description thereof is omitted.

The magic word may also be a word, a phrase or any character string. In one implementation the magic word generation unit 204 comprises a memory and a selector. A digital dictionary or a set of predetermined words is stored as a database in the memory. The selector randomly selects the word in the database as the magic word. In another implementation, the magic word generation unit 204 comprises a character string generator, which randomly selects characters to fill a string array, and transforms the array to a character string. Any character can be used in the magic word as long as it can be inputted by a peer's terminal and can be recognized by the identifier service provider.

When the magic word is typed by the subscriber, rather than generated automatically, the magic word generation unit 204 is simply a register, which is coupled to the input unit of the subscriber's terminal and stores the numbers or characters inputted by the subscriber as the magic word. In another implementation, the magic word becomes valid after being confirmed by the subscriber. In particular, the magic word generation unit 204 generates the magic word and shows the generated magic word on the display of the subscriber's terminal. The subscriber determines whether this magic word is acceptable. If the subscriber satisfies with the generated magic word, he/she inputs a command indicating that the generated magic word is OK through the input unit of the terminal. Upon receiving such command, the magic word generation unit 204 makes that magic word valid and stores it. Otherwise, the subscriber inputs a command indicating that the generated magic word is not acceptable, and the magic word generation unit 204 abandons this magic word and begins to generate another magic word.

Several examples of the method for generating a magic word and the corresponding implementations of the magic word generation unit 204 have been described above. However, the magic word may be generated under various conditions. It should be understood by those skilled in the art that many modifications of the magic word generation unit 204 may be made to adapt to a particular situation.

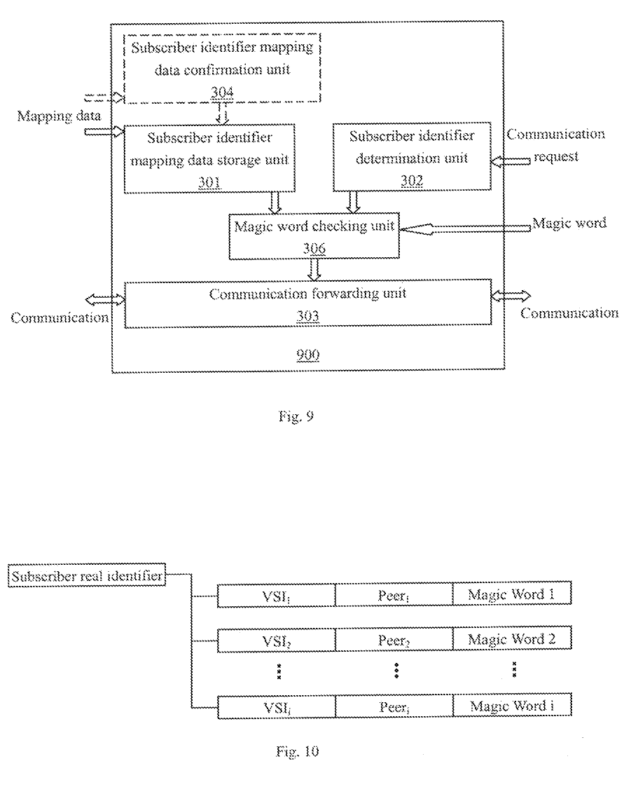

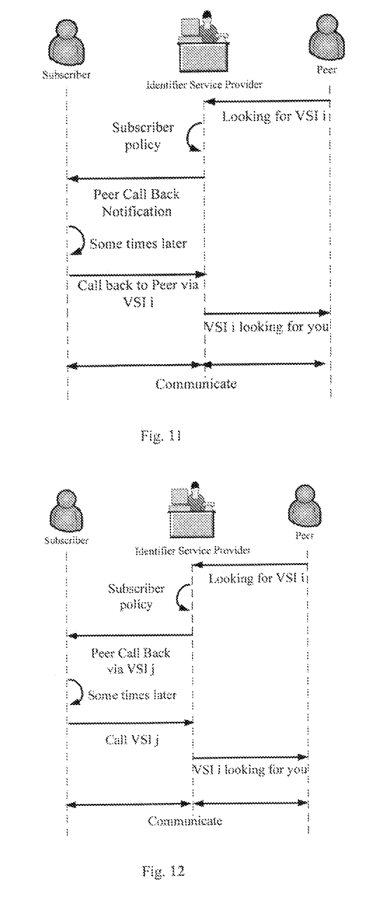

FIG. 9 is a block diagram illustrating the example of the identifier service provider according to this embodiment. The identifier service provider 900 is similar to that shown in FIG. 3, but further comprises a magic word checking unit 306 for checking whether the magic word received from the originator conforms to that stored in the subscriber identity mapping data storage unit 301. If they are matched, the identifier service provider forwards the communication. Otherwise, the identifier service provider may ask the originator to input the magic word again.

The identifier service provider can help the subscriber maintain the information such as to whom a certain VSI is given out as well as the magic word. FIG. 10 illustrates the dataset maintained by the identifier service provider in order to ease the VSI management by subscriber.

With the help of a magic word, the identifier service provider can decrease the possibility when a peer wrongly originates communication to a VSI, e.g. incorrectly dials a virtual phone number.

The identifier service provider may set up various policies for forwarding the communication by the virtual subscriber identifier.

In one embodiment, the identifier service provider may comprise a call back notification unit for sending a call back notification to the subscriber. FIG. 11 is a diagram illustrating the process according to this embodiment. Conceivably, the subscriber is able to originate communication to peer via VSI i. In another embodiment, the subscriber calls back via VSI j as illustrated in FIG. 12.

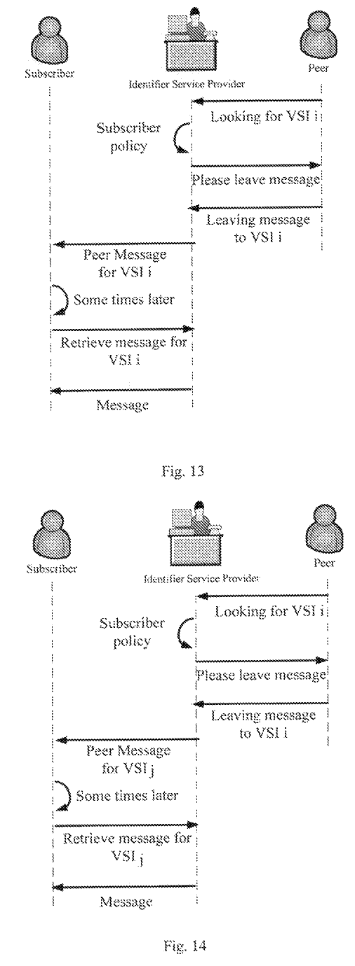

In addition, peer may leave a message to VSI i. In one embodiment, the identifier service provider may comprise a message leaving unit for storing the message left by the peer and informing the subscriber of the message. FIG. 13 is a diagram illustrating the process according to this embodiment. The identifier service provider notifies the subscriber that peer has left a message to VSI i. Some times later, the subscriber may contact the identifier service provider to retrieve the message. Alternatively, the identifier service provider may notify the subscriber that a message left by peer for VSI i has been stored at VSI j. The subscriber directly connects to VSI j and retrieves the message that peer leaves for VSI i. FIG. 14 illustrates the above case.

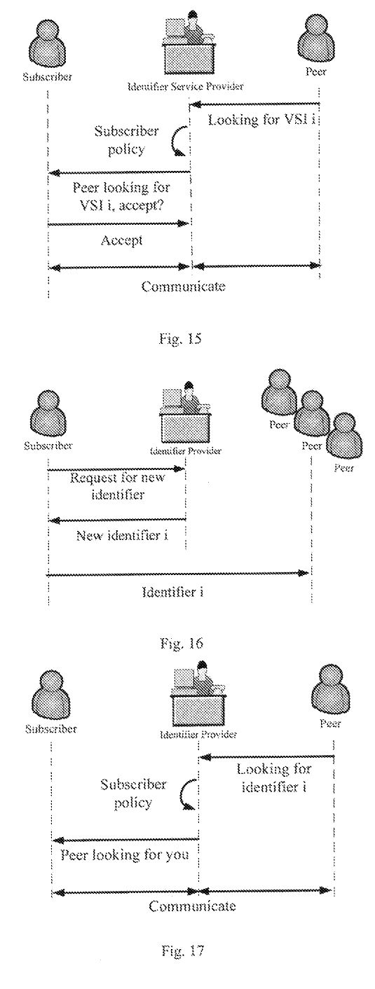

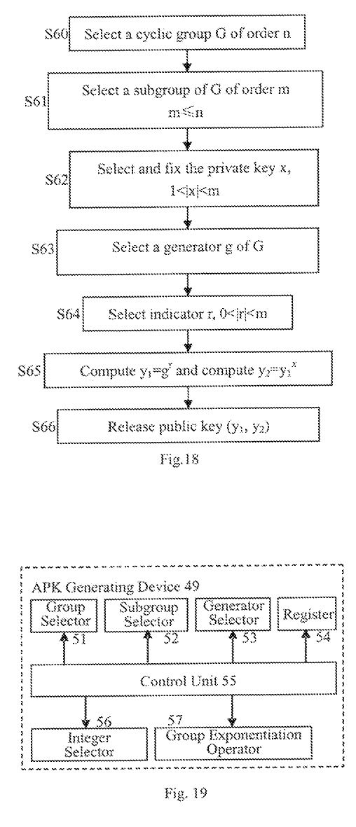

FIG. 15 illustrates the case that identifier service provider asks for confirmation of the subscriber before peer communication is connected to the subscriber.

According to the embodiments of the invention, the subscriber generates VSI instead of being issued by identifier service provider. This is more flexible to the system and handy to the subscriber. The subscriber may directly give the VSI to peer if certain certificate data is attached by which the peer can verify the authenticity of the VSI and the identifier service provider can figure out the owner of the VSI.

According to one embodiments of the invention, the identifier service provider can help maintain the mapping between real subscriber, VSI, peer corresponding magic word. This dramatically facilitates the subscriber management of many VSIs. The magic word introduced can help reduce the probability when a peer wrongly originates communication with a VSI, or the VSI has been occupied by another subscriber.

According to one embodiments of the invention, the identifier service provider can notify the subscriber a call back request from peer. The subscriber can either use his/her VSI to call back to peer, or the subscriber can call a special VSI generated by the identifier service provider by which the identifier service provider will automatically connect to the peer.

According to one embodiments of the invention, the identifier service provider can notify the subscriber that a peer has left a message for his/her VSI. The subscriber can either contact the identifier service provider via his/her VSI to retrieve the message, or the subscriber can call a special VSI generated by the identifier service provider to which the identifier service provider will automatically deliver the message.

According to one embodiments of the invention, the identifier service provider can ask confirmation of the subscriber before peer communication targeted at a subscriber's VSI in really connected to the subscriber.

The present invention may be implemented in hardware, software, firmware or a combination thereof and utilized in systems, subsystems, components or sub-components thereof. When implemented in software, the elements of the present invention are essentially the code segments used to perform the necessary tasks. The program or code segments can be stored in a machine readable medium or transmitted by a data signal embodied in a carrier wave over a transmission medium or communication link. The “machine readable medium” may include any medium that can store or transfer information. Examples of the machine readable medium include an electronic circuit, a semiconductor memory device, a ROM, a flash memory, an erasable ROM (EROM), a floppy diskette, a CD-ROM, an optical disk, a hard disk, a fiber medium, a radio frequency (RF) link, etc. The data signal may include any signal that can propagate over a transmission medium such as electronic network channels, optical fibers, air, electromagnetic, RF links, etc. The code segment may be downloaded via computer networks such as the Internet, Intranet, etc.

The invention may be embodied in other specific forms without departing from the spirit or essential characteristics thereof. For example, the algorithms described in the specific embodiment can be modified while the system architecture does not depart from the basic spirit of the invention. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

APK Technique

The APK technique will be described with reference to FIGS. 18-20.

In APK technique, the term “group” refers to the mathematics concept defined as follows unless otherwise indicated:
A group (G, ⋄) consists of a set G with a binary operation ⋄ on G satisfying the following three axioms:
(i) the Group operation is associative. This is, a ⋄(b⋄c)=a⋄b) ⋄c for all elements a, b, c of G:
(ii) There is an identity element e of G such that a⋄e=e⋄a=a for all elements a of G; and
(iii) For each element a of G there exists an element a⁻¹ of G, called the inverse of a, such that a ⋄a⁻¹=a⁻¹⋄a=e.

For example, the set of integers Z with operation of addition forms a group. The identity element is 0 and the inverse of an integer a is the integer −a. For more information, please refer to Handbook of Applied Cryptography, available online at http://www.cacr.math. uwaterloo.ca/hac/.

FIG. 18 shows the exemplary process flow for generating APK/private key pairs. FIG. 19 shows the exemplary device 49 for generating anonymous public keys in accordance with the APK technique. First, a group G is selected by the Group Selector 51 (Step S60). For example, a computer may have memory in which various data structures representing various eligible groups are stored. Under the control of the Control Unit 55, the Group Selector 51 selects one group by selecting the data structure representing the group. In actual practice, there are already some commercial function libraries that can run on the computer and provide such services. An application program that intends to implement APK technique may call, with some specific parameters, a particular function provided by such libraries. And then the called function can return the desired group(s). In one complementation, G is a finite cyclic group and its order is n, which is a positive integer. Candidates of the finite cyclic group G include but as not limited to:
a group of points on an elliptic curve over a finite field F_{q1};
a multiplicative group F_{q2}* of a finite field F_{q2}, where q2=p^{m1}, m1 is a positive integer and p is a prime;
the group of Zₙ₁*, where n1 is a composite integer; and
a multiplicative group of Zₙ₂*, where n2 is a prime.

Among the above four exemplary kinds of groups, the first group may have the best security performance, while the latter three are more commonly used in the art. The “finite cyclic” nature of group G guarantees that the result of group exponentiation operation will eventually be mapped into group G; however the mapping methods may vary from group to group. Besides, it also guarantees the existence of a generator.

Then, the Subgroup Selector 52 selects a subgroup of G of order m, where m<n (Step S61). If m is selected as a prime, it will have the preferred security performance. Please note that the subgroup can be selected as G itself, which also means m=n. As in an alternative complementation, on the premise that after the group G is determined or selected, the selection of the subgroup can be omitted, which also means G itself is implicitly selected as the subgroup, since G is a subgroup of itself mathematically. That is also to say, when G itself is selected as the subgroup, which causes m=n, such a selection is seemingly dismissed. Of course, if the selection of the subgroup is omitted, the Subgroup Selector 52 (as described in FIG. 19) can also be omitted.

Then, the Integer Selector 56 selects an integer as the private key x, such that x satisfies 1<|x|<m (Step S62). It is to be understood that one terminal may have a plurality of private keys, although the description herein is focused on how to generate a plurality of public keys from one private key, for the sake of simplicity.

Then, the Generator Selector 53 selects and fixes a generator g of group G (Step S63). If G is a finite cyclic group, it always has at least one generator. It is to be noted that the selections of g and x is independent from each other. That is to say, although Step S62 is described prior to Step S63 here, the order of their performance can be reversed or they can be performed in parallel.

After the selection of G, m, x and g, an integer r is selected as the indicator that satisfies 0<|r|<m to generate a new public key under the control of the Control Unit 55 (Step S64).

With the selection of G, m, x, g and r, a new public key is generated with the computation of y₁=g^{r} and then y₂=y₁^{x} (Step S65). Then the public key (y₁,y₂) can be released (Step S66) to the Receiver for encryption. Of course, there may be other information that is also released together with the public key.

It is to be noted that the selection of g, x, and r has no sequential and dependency requirement between their selections, such that Steps S62, S63, S64 can be performed in any order, sequentially or concurrently. In addition, the selection of g, x and r may be at random or in accordance with some criteria as desired.

Alternately, some of the aforementioned procedures may be omitted by the Control Unit 55, but performed elsewhere. For example, the group G and the subgroup can be assigned by a third party such as an entrust organization. Hence the Control Unit 55 skips steps of selecting the group and subgroup, since they are now determined externally. Further, if one anonymous public key has been previously generated, it is for certain that the group, subgroup, generator and private key all have been selected and fixed. Therefore when a new public key is to be generated, the Control Unit 55 skips these four steps and goes directly to the following steps.

If y₁ or y₂ is originally outside the range of group G, they must be mapped into group G. The mapping methods may vary for different groups. However, the cyclic group G guarantees the existence of such mapping method.

It is to be noted that the foregoing steps may be performed either in one single device/module (with integrated or discrete components) of a system, or in a distributed manner with respective devices of the system performing some of the steps, respectively.

An example of the group, subgroup and generator selection is described below. Suppose group Zₚ* is selected where p=11, hence Z₁₁*={1, 2, 3, 4, 5, 6, 7, 8, 9, 10}. Since 11 is a prime, mathematically the order of Z₁₁* is 11−1=10. The element 2 is a generator of Z₁₁* as can be easily verified that Z₁₁*={2ⁱ mod 11/i=0,1, . . . , 9}. since a group is also a subgroup of itself, the subgroup may be chosen as Z₁₁*. Another choice of subgroup for example is {1, 3, 4, 5, 9} which has the generator 3 of order 5. Again it's easy to verify that 35=1 mod 11.

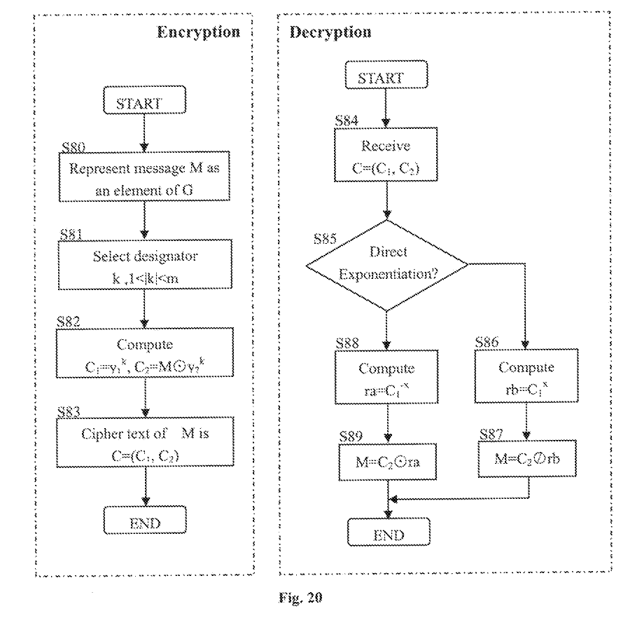

The exemplary method primarily described in FIG. 18 is only one of the numerous methods available for generating anonymous public keys according to APK technique. There are more advanced methods that not only can be used for the same purpose, but also can achieve optimization in performance. To describe the optimization methods, the encoding and decoding procedures well known in the art are briefly summarized with reference to FIGS. 18, 19 and 20, wherein □ is a group G invertible operation and Ø is the exact inverse operation of □. The APK technique has been applied in the procedures in FIG. 20.

To encrypt a plain text M, M is first represented as an element of G (for example, M is represented as its ASCII code) (Step S80), then an integer k is selected as the designator satisfying 1<|k|<m (Step S81) and a pair of values are computed as follows (Step S82)
C₁=y₁^{k}, and
C₂=M ⊙y₂^{k},
where C₁ and C₂ are group G members. Examples of ⊙ can be multiplication, division, addition or subtraction of Group G. The mapping methods may vary for different groups.

At this time, the cipher text of the message M is obtained as C=(C₁, C₂) (Step S83) and it can be sent out over a communication channel.

For a message M that is outside the range of group G to be encoded, it must be transformed into several group members before encoding. Following subsequent decoding, the recovered group members may be transformed back to the original message. The transformation methods may vary for different groups. One example is breaking the message onto several blocks, each of which is a member of group G, and concatenating all the blocks to reconstruct M.

At the other side of the communication channel, the cipher-text message C is received (Step S84). To retrieve the plain text M from the cipher text C, first it has to be decided between two ways, direct exponentiation or not (Step S85). If yes, rb=C₁^{x} is first computed (Step S86) and then M is obtained by computing M=C₂Ørb (Step S87); otherwise, ra=C₁^{-x} is first computed (Step S88) and then M is obtained by computing M=C₂⊙ra (Step S89).

After successful decryption of a cipher text (C₁, C₂) depending on the implementation of decryption, the APK Generating Device 49, in accordance with the APK technique, may make use of the received cipher text as well as the intermediate decryption output ra to generate a new anonymous public key in the form of (y₁=C₁⁻¹, y₂=ra). Similarly, the APK Generating Device 49 may make use of the received cipher text as well as the intermediate decryption output rb to generate a new anonymous public key in the form of (y₁=C₁, y₂=rb). In either way of generating a new anonymous public key, the exponentiation operation is avoided and computation efficiency is enhanced.

Furthermore, when a single anonymous public key (y₁y₂) is provided, the APK Generating Device 49 may generate a new anonymous public key in the form of (y₂, y₂^{x}). This method can be utilized multiple times to generate a chain of public keys. This way, storage consumption of the public keys generated are heavily reduced since the second portion of the public key, y₂, is identical to the first portion of its following. For a chain of w public keys, up to (w−1)2w percentage of storage are saved which implies approximate 50% saving for w large enough.

IN APK technique, since the public keys are generated with the same generator based on the form of powers of the generator, the powers of the generator g can be reused to generate a series of public keys, which involves multiplication, instead of exponentiation, thus saving the memory storage and accelerating the computation. Meanwhile, since only one table of the powers of the generator needs to be maintained in the decoding device, the computation of new public keys can be performed off-line.

For example, in an complementation, when a cipher text message C=(C₁,C₂) is received in the decoding device, C1 can be retrieved and utilized to generate new public keys. As described, C₁=y₁^{k}=g^{rk}, and g^{rk} can be saved to generate new public keys because the product “rk” is only another integer. It is to be noted that although g^{rk} can be saved to generate new public keys, the value of rk may still be unknown to the decoding device, unless the encoding device revealed k when sending the encrypted message.

When a single anonymous public key (y₁, y₂) is provided, the APK Generating Device 49 may generate a new anonymous public key in the form of (y₁×y₁, y₂×y₂), where × is group multiplication. In general, if there are provided several anonymous public keys (y₁₁, y₂₁) (y₁₂, y₂₂), . . . , (y₁ⱼ, y₂ⱼ), j≧2, based on the plurality of stored powers of g, y₁₁=g^{r1}, y₁₂=g^{r2}, . . . , y₁ⱼ=g^{rj}, and y₂₁=y₁₁*, y₂₂=y₁₂^{x}, . . . , y₂ⱼ=y₁ⱼ^{x}, a new public key can be computed as (y₁₍ⱼ₊₁₎=y₁₁y₁₂ . . . y₁ⱼ, y₂₍ᵣ₊₁)=y₂₁y₂₂ . . . y₂ⱼ), where y₁₁y₁₂ . . . y₁ⱼ is the product of y₁₁, y₁₂, . . . , y₁ⱼ, y₂₁y₂₂ . . . y₂ⱼ is the product of y₂₁, y₂₂, . . . , y₂ⱼ. Clearly, to generate a new anonymous public key, the exponentiation operation is replaced by multiplication and computation efficiency is enhanced. Since multiplication can be carried out online, new public keys generated in this way may not need to be pre-computed, which directly implies saving of storage space.

The above optimization techniques may be jointly used to generate new anonymous public keys. For instance, upon receiving and after successful decryption of a series of cipher texts (C₁₁, C₂₁), (C₁₂, C₂₂) . . . (C₁ⱼ, C₂ⱼ), j≧2, the APK Generating Device 49 can make use of the received cipher texts as well as the intermediate decryption outputs rb₁, rb₂, . . . , rbⱼ to generate a new anonymous public key in the form of (y₁=(C₁₁C₁₂ . . . C₁ⱼ), y₂=(rb₁rb₂ . . . rbⱼ)), where C₁₁C₁₂ . . . C₁ⱼ is the product of C₁₁, C₁₂, . . . , C₁ⱼ, rb₁rb₂ . . . rbⱼ is the product of rb₁, rb₂, . . . , rbⱼ.

Furthermore, with the computation of y₂, a series of public keys can be computed as (y₂^{w1}, y₂^{w2}), where w₁=x^{w}, w₂=x^{(w+1)}, w≧0. Furthermore, all of the results, specifically the powers of g, obtained in this computation can be utilized to generate further public keys. Furthermore, based on C₁ retrieved from the cipher-text message C, the decoding device can generate more new public keys. For this purpose, C₁^{x} and C₁^{-x} can be computed and saved, and then two series of public keys can be generated. In general, when a plurality of encrypted messages CC₁=(C₁₁,C₁₂), CC₂=(C₂₁,C₂₂), . . . , CC₁=(Cⱼ₁, Cⱼ₂) are received, for the case of C₁^{x}, a series of new public keys can be generated as ((C₁₁C₂₁ . . . Cⱼ₁)^{u1}, (C₁₁C₂₁ . . . Cⱼ₁)^{u2}), where C₁₁C₂₁ . . . Cⱼ₁ is the product of C₁₁, C₂₁, . . . , Cⱼ₁, j≧1, u1=x^{u}, u2=x^{(u+1)} and u≧0, and for the case of C₁^{-x}, another series of new public keys can be generated as ((C₁₁C₂₁ . . . Cⱼ₁)^{v1}, (C₁₁C₂₁ . . . Cⱼ₁)^{v2}), where C₁₁C₂₁ . . . Cⱼ₁ is the product of C₁₁, C₂₁, . . . , Cⱼ₁,j≧1, v1=−x^{v}, v2=−x^{(v+1)} and v ≧0. Furthermore, all of the results, specifically the power os g, obtained in this computation can be utilized to generate further public keys.

1. A subscriber terminal in a communication network, comprising:
virtual subscriber identifier generation means for generating a virtual subscriber identifier;
subscriber identity mapping data generation means coupled to said virtual subscriber identifier generation means, said subscriber identity mapping data generation means being adapted to generate a subscriber identifier to the real identifier of said subscriber; and
communication means communicatively coupled to the identifier service provider, said communication means being adapted to communicate with other subscriber terminals using said virtual subscriber identifier via the identifier service provider.

2. The subscriber terminal of claim 1, wherein said virtual subscriber identifier generation means generates the virtual subscriber identifier as a hash value of a public key or a hash value of a combination of a public key and a number.

3. The subscriber terminal of claim 2, wherein said public key is an incomparable public key or an anonymous public key.

4. The subscriber terminal of claim 1, wherein said subscriber identity mapping data comprises and real identifier of the subscriber and said virtual subscriber identifier corresponding therewith, and said subscriber terminal further comprises subscriber identity registering means coupled to said subscriber identity mapping data generation means, said subscriber identity registering means being adapted to register said subscriber identity mapping data with said identifier service provider.

5. The subscriber terminal of claim 4, further comprises magic word generation means coupled to said subscriber identity registering means, said magic word generation means being adapted to generate a magic word corresponding to said virtual subscriber identifier, said magic word being registered by said subscriber identity registering means in association with said subscriber identity mapping data for checking validity of use of the virtual subscriber identifier.

6. The subscriber terminal of claim 1, wherein said subscriber identity mapping data generation means includes a secret data generation unit for generating a secret data corresponding to said real identifier of the subscriber such that said identifier service provider can discover said real identifier of the subscriber from said secret data, and said subscriber identity mapping data comprises said secret data.

7. The subscriber terminal of claim 6, wherein said secret data generation unit generates said secret data by encrypting said real identifier of the subscriber with a public key of the identifier service provider, and said subscriber identity mapping data generation means generates said subscriber identity mapping data as a certificate data incorporating said secret data.

8. A method for a subscriber to communicate with peers over a communication network while preserving said subscriber's privacy, comprising:
generating a virtual subscriber identifier;
generating a subscriber identity mapping data used for an identifier service provider to associate said virtual subscriber identifier to the real identifier of said subscriber;
informing at least one peer of said virtual subscriber identifier; and
communicating with said peer using said virtual subscriber identifier via the identifier service provider, wherein the real identifier of the owner of said virtual subscriber identifier is determined by said virtual subscriber identifier based on said identity mapping data.

9. The method of claim 8, wherein said virtual subscriber identifier is generated as a hash value of a public key or a has value of a combination of a public key and a number.

10. The subscriber terminal of claim 9, wherein said public key is an incomparable public key or an anonymous public key.

11. The method of claim 8, wherein said subscriber identity mapping data comprises said real identifier of the subscriber and said virtual subscriber identifier corresponding therewith, and wherein said method further comprises registering said subscriber identity mapping data with said identifier service provider.

12. The method of claim 11, further comprising generating a magic word corresponding to said virtual subscriber identifier, said magic word being used by said identifier service provider for checking validity of use of the virtual subscriber identifier, and wherein
said registering comprises registering said magic word in association with said subscriber identity mapping data with said identifier service provider; and
said informing comprises informing said peer of said magic word in association with said virtual subscriber identifier.

13. The method of claim 8, wherein said generating a subscriber identity mapping data comprises generating a secret data corresponding to said real identifier of the subscriber such that said identifier service provider can discover said real identifier of the subscriber from said secret data, and said informing comprises informing said peer of subscriber identity mapping data in association with said virtual subscriber identifier, wherein subscriber identity mapping data comprises said secret data.

14. The method of claim 13, wherein said secret data is generated by encrypting said real identifier of the subscriber with a public key of the identifier service provider, and said subscriber identity mapping data is generated as a certificate data incorporating said secret data.

15. A communication server for forwarding a communication in a communication network, comprising:
subscriber identity mapping data storage means for storing subscriber identity mapping data, said identity mapping data being used for an identifier service provider to associate a virtual subscriber identifier generated by a subscriber to the real identifier of said subscriber;
subscriber identity determination means coupled to said subscriber mapping data storage means, wherein in response to a communication request including said virtual subscriber identifier as target from a peer of said subscriber, said subscriber identity determination means determines the real identifier of the owner of said virtual subscriber based on said subscriber identity mapping data; and
communication forwarding means coupled to said subscriber identity determination means, said communication forwarding means being adapted to forward the communication between said peer and the terminal of said determined subscriber.

16. The communication server of claim 15, wherein said subscriber identity mapping data is received from said subscriber and comprises said real identifier of the subscriber and said virtual subscriber identifier corresponding therewith, and said subscriber identity mapping data storage means stores a dataset in which said virtual subscriber identifier is associated with said real identifier of said subscriber.

17. The communication server of claim 16, further comprising subscriber identity mapping data confirmation means for checking availability of the virtual subscriber identifier generated by said subscriber, and generating registration confirmation notification to said subscriber.

18. The communication server of claim 16, wherein
said subscriber identity mapping data storage means further stores a magic word received from said subscriber in association with said subscriber identity mapping data;
said communication server further comprises magic word checking means for checking whether the magic word received from said peer conforms to that stored in association with subscriber identity mapping data; and
said communication forwarding means forwards the communication between said peer and said subscriber's terminal only if the magic word received from said peer conforms to the stored magic word.

19. The communication server of claim 15, wherein
said subscriber identity mapping data is received from said peer and comprises a secret data corresponding to the real identifier of the subscriber; and
said subscriber identity determination means comprises a decryption unit for decrypting said secret data to discover said real identifier of said subscriber.

20. The communication server of claim 19, wherein said decryption unit decrypts said secret data with a private key of said communication server.

21. The communication server of claim 15, further comprising a call back notification unit for sending a call back notification to the subscriber.

22. The communication server of claim 15, further comprising a message leaving unit for storing the message left by said peer and informing said subscriber of said message.

23. A method for forwarding a communication in a communication network, comprising:
receiving subscriber identity mapping data, said identity mapping data being used for associating a virtual subscriber identifier generated by a subscriber to the real identifier of said subscriber;
storing said subscriber identity mapping data in a memory;
receiving a communication request from a peer of said subscriber, said communication request including said virtual subscriber identifier as target;
determining the real identifier of the owner of said virtual subscriber identifier from said subscriber identity mapping data; and
forwarding the communication between said peer and said subscriber's terminal.

24. The method of claim 23, wherein said subscriber identity mapping data is received from said subscriber and comprises said real identifier of the subscriber and said virtual subscriber identifier corresponding therewith, and said storing comprises storing a dataset in which said virtual subscriber identifier is associated with said real identifier of said subscriber.

25. The method of claim 24, further comprising checking availability of the virtual subscriber identifier generated by said subscriber, and generating registration confirmation notification to said subscriber.

26. The method of claim 24, further comprising:
receiving a magic word corresponding to said virtual subscriber identifier from the subscriber;
storing said magic word in association with said subscriber identity mapping data;
receiving a magic word from said peer; and
comparing the magic word received from said peer with the magic word stored,
wherein the communication is forwarded only if the magic word received from said upper conforms to the stored magic word.

27. The method of claim 23, wherein said subscriber identity mapping data is received from said peer and comprises a secret data corresponding to the real identifier of the subscriber, and the method further comprising:
decrypting said secret data to discover said real identifier of said subscriber.

28. The method of claim 27, wherein said decrypting comprises decrypting said secret data with a private key.

29. A method for communication over a communication network while preserving privacy, wherein the network comprises at least one subscriber terminal, at least one peer of the subscriber terminal and an identifier service provider coupled to said subscriber terminal and said peer, the method comprising:
said subscriber terminal generates a virtual subscriber identifier and a subscriber identity mapping data used for said identifier service provider to associate said virtual subscriber identifier to the real identifier of said subscriber, and informs said peer of said virtual subscriber identifier;
said peer generates a communication request including said virtual subscriber identifier as target, and sends the request to said identifier service provider; and
said identifier service provider determines the real identifier of said subscriber from said subscriber identity mapping data, and forwards the communication between said upper and said subscriber terminal.

30. The method of claim 29, wherein said virtual subscriber identifier is generated as a hash value of a public key or a has value of a combination of a public key and a number.

31. The method of claim 30, wherein said public key is an incomparable public key or an anonymous public key.

32. A system for communication by virtual identifiers over a communication network, comprising at least one subscriber terminal, at least one peer and a communication server coupled to said subscriber terminal and said peer, wherein said subscriber terminal comprises
virtual subscriber identifier generation means for generating a virtual subscriber identifier;
subscriber identity mapping data generation means coupled to said virtual subscriber identifier generation means, said subscriber identity mapping data generation means being adapted to generate a subscriber identity mapping data used for an identifier service provider to associate said virtual subscriber identifier to the real identifier of said subscriber, and
communication means communicatively coupled to the identifier service provider, said communication means being adapted to communicate with other subscriber terminals using said virtual subscriber identifier via the identifier service provider, and
said identifier service provide comprises
subscriber identity mapping data storage means for storing said subscriber identity mapping data; and
subscriber identity determination means coupled to said subscriber mapping data storage means, wherein in response to a communication request including said virtual subscriber identifier as target from said, said subscriber identity determination means determines the real identifier of the owner of said virtual subscriber identifier based on said subscriber identity mapping data, and
communication forwarding means coupled to said subscriber identity determination means, said communication forwarding means being adapted to forward the communication between said peer and the terminal of said determined subscriber.

33. The system of claim 32, said virtual subscriber identifier generation means generates the virtual subscriber identifier as a hash value of a public key or a hash value of a combination of a public key and a number.

34. The subscriber terminal of claim 33, wherein said public key is an incomparable public key or an anonymous public key.

35. A manufactured article having a machine readable medium with instructions recorded thereon which, when executed by one or more processors, causes the processor to:
generating a virtual subscriber identifier and a subscriber identity mapping data used for associating said virtual subscriber identifier with the real identifier of a subscriber;
informing at least one peer of said virtual subscriber identifier; and
communicating with said peer using said virtual subscriber identifier via said identifier service provider, wherein the real identifier of the owner of said virtual subscriber identifier is determined by said virtual subscriber identifier based on said identity mapping data.

36. A manufactured article having a machine readable medium with instructions recorded thereon which, when executed by one or more processors, causes the processors to:
receiving subscriber identity mapping data, said identity mapping data being used for associating a virtual subscriber identifier generated by a subscriber to the real identifier of said subscriber;
storing said subscriber identity mapping data in a memory;
receiving a communication request from a peer of said subscriber, said communication request including said virtual subscriber identifier as target;
determining the real identifier of the owner of said virtual subscriber identifier from said subscriber identity mapping data; and
forwarding the communication between said peer and said subscriber's terminal.
